(19) United States
(12) Patent Application Publication
(10) Pub. No.: US 2014/0278559 A1
(43) Pub. Date: Sep. 18, 2014

(54) ADJUDICATION PLATFORM COMPLIANCE MANAGEMENT

(71) Applicant: INTERNATIONAL BUSINESS MACHINES CORPORATION, (US)

(72) Inventors: Aharon Abadi, Eilat (IL); Jonathan Bnayahu, Haifa (IL); Moti Nisenson, Haifa (IL)

(73) Assignee: INTERNATIONAL BUSINESS MACHINES CORPORATION, Armonk, NY (US)

(21) Appl. No.: 13/798,177

(22) Filed: Mar. 13, 2013

(51) Int. Cl. G06Q 40/08

(52) U.S. Cl. CPC G06Q 40/08
USPC 705/4

(57) ABSTRACT

A method of verifying compliance of an adjudication platform with a requirement, the method comprising: applying a requirement to an adjudication platform, wherein said adjudication platform comprises a plurality of benefit rules and said requirement comprises a plurality of requirements representing at least one of a law and an insurance policy; identifying at least one of said plurality of benefit rules disagreeing with at least one of said plurality of requirements, responsive to a discrepancy between applied said requirement and said adjudication platform; outputting at least one of identified said plurality of benefit rules and said plurality of requirements.

### BACKGROUND

The present invention, in some embodiments thereof, relates to adjudication platforms and, more specifically, but not exclusively, to verification of multi-aspect adjudication platforms compliance with requirements and ongoing management of multi-aspect adjudication platforms.

Adjudication platforms are tools implementing insurance policies. Automated and semi-automated adjudication platforms are used in different fields of everyday life, such as banking, actuary and insurance. Banking adjudication platforms may be used to determine customers' commission rates according to variables pertaining to the individual customer, for example overall asset holdings and credit history. In the field of property insurance, adjudication platforms are used to apprise the equitable transfer of the risk of a loss, according to variables such as the situation which led to the damage, monetary value of stolen goods in case of a theft, and/or the like. Adjudication platforms are typically complex, such that decision making in such platforms is performed according to many adjudication platform aspects.

Customization of adjudication platforms according to the individual needs of different clients is sometimes required. In the field of health insurance, for example, healthcare providers implement an adjudication program which is typically a standard insurance product. The insurance product dictates treatments and procedures to be supplied at a reduced cost to a client by a Preferred Provider Organization (PPO). A client may request certain exceptions as a condition for renewal of a health adjudication platform such that, when implemented, the client's health adjudication platform no longer conforms to strictly PPO.

Adjudication platforms are often implemented as software. Some of the common uses of computerized adjudication platforms are claim processing by healthcare providers and/or paying entities, and claim pre-processing for predicting service approval. Patient services provided by healthcare providers, such as hospitals, clinics, physicians or practitioner nurses are reimbursed by paying entities such as a healthcare institution or a fellow healthcare provider. The reimbursement process often begins by sending claims to paying entities. Claims are provided electronically or in a paper format. Electronic claims are processed in adjudication platforms of paying entities. The claims are interpreted and their status is determined as pay in full, partial payment or denied. The level of automation in such a process varies from fully automated to manual, with many intermediate levels.

### SUMMARY

According to an aspect of some embodiments of the present invention there is provided a computerized method of verifying compliance of a plurality of benefit rules with a plurality of requirements, the method comprising: acquiring a plurality of benefit rules of an adjudication platform; applying a plurality of requirements representing at least one of a law and a policy to the plurality of benefit rules; identifying at least one of the plurality of benefit rules disagreeing with at least one of the plurality of requirements, responsive to a discrepancy between applied plurality of requirements and the plurality of benefit rules; outputting at least one of identified the plurality of benefit rules and the plurality of requirements.

Optionally, the method applies a plurality of requirements to the plurality of benefit rules is performed by: identifying a plurality of assignments for at least one of the plurality of requirements; associating at least one subset of the plurality of assignments with at least one of the plurality of benefit rules according to agreement of the at least one subset with the at least one of the plurality of benefit rules; choosing a second benefit rule from the plurality of benefit rules according to at least one relationship of the second benefit rule with the at least one of the plurality of benefit rules; adding at least one assignment for the second benefit rule to the at least one subset; comparing an eligibility result of the second benefit rule with an expected result of the at least one of the plurality of requirements. Optionally, the method further comprises repeating the choosing and adding until at least one of getting to an eligibility result and identifying a logical contradiction between the plurality of assignments. Optionally, the plurality of assignments includes all possible assignments. Optionally, the plurality of assignments comprises at least one of a plurality of numerical eligibility characteristics, a plurality of textual tags, and a plurality of formulas. Optionally, discrepancy between applied plurality of requirements and the plurality of benefit rules is at least one of: a contradiction between the plurality of assignments, a contradiction between a plurality of variables of an assignment from the plurality of assignments, an empty assignment set, a difference in an eligibility result of at least one of the plurality of benefit rules and an eligibility result of at least one of the plurality of requirements and a benefit rule which is never assessed. Optionally, at least one relationship is at least one of a sequence and a hierarchy. Optionally, identifying a plurality of assignments for at least one of the plurality of requirements is performed by at least one of satisfiability solver, theorem prover and abstract interpretation. Optionally, the method further comprises: automatically recognizing a revision of at least one of the plurality of benefit rules; automatically repeating the applying, the identifying and the outputting responsive to the revision. Optionally, the method further comprises: automatically recognizing a revision of at least one of the plurality of requirements; repeating the applying, the identifying and the outputting upon a revision of the plurality of benefit rules. Optionally, at least one of a law and a policy comprises a member of a group consisting of: a state regulation, a state law, a federal regulation, a federal law, and guidelines of an insurance policy. Optionally, the plurality of requirements is generated by converting at least one of a law and a policy. Optionally, the method further comprises: translating each of the plurality of benefit rules to at least one logical language statement; representing the at least one logical language statement as a mathematical graph. Optionally, the mathematical graph comprises a plurality of nodes and a plurality of edges; and the representing the at least one logical language statement as a mathematical graph comprises associating a plurality of propagation functions with the plurality of edges, wherein each propagation function is one or more conditional instructions determining data flow along associated edge according to validity of the conditional instructions. Optionally, the method further comprises: associating at least one subset of a plurality of assignments with at least one of the plurality of propagation functions. Optionally, the plurality of benefit rules complies with the plurality of requirements the outputting comprises a compliance indication. Optionally, the plurality of benefit rules represents an adjudication platform; the plurality of requirements represents the adjudication platform; and a representation of the plurality of benefit rules differs from a representation of the plurality of requirements. Optionally, the method further comprises: acquiring a relationships database indicating at least one of: a plurality of relationships between a plurality of benefit rule eligibility characteristics, each defining a characteristic for complying with a benefit rule; a plurality of relationships between a plurality of requirement eligibility characteristics, each defining a characteristic for complying with a requirement; a plurality of relationships between at least one of the plurality of benefit rule eligibility characteristics and at least one of the plurality of requirement eligibility characteristics; wherein the identifying at least one of the plurality of benefit rules disagreeing with at least one of the plurality of requirements, utilizes at least one of the plurality of relationships of the relationships database. Optionally, the plurality of relationships comprises: a type-of relationship, a containing relationship, a part-of relationship and a is-a relationship.

According to some embodiments of the invention, there is provided a computerized method of verifying self consistency of an adjudication platform, the method comprising: assigning at least one of a plurality of formulas and a plurality of eligibility characteristics to a plurality of benefit rules representing an adjudication platform; identifying a fault in at least one of the plurality of benefit rules, the fault comprising: a contradiction between the plurality of benefit rules, repetition of a benefit rule, a benefit rule which is always true, a benefit rule which is always false and a benefit rule which is never assessed.

According to some embodiments of the invention, there is provided a computer program product for verifying compliance of a plurality of benefit rules with a plurality of requirements, comprising: a computer readable storage medium; first program instructions to apply a plurality of requirements to plurality of benefit rules; second program instructions to identify a discrepancy between applied the plurality of requirements and the plurality of benefit rules; and third program instructions to output the discrepancy; wherein the first, second and third program instructions are stored on the computer readable storage medium.

According to an aspect of some embodiments of the present invention there is provided a system for verifying compliance of a plurality of benefit rules with a plurality of requirements, the system comprising: a processor; a calculation module which, using the processor, applies a plurality of requirements to a plurality of benefit rules, wherein the calculation module identifies at least one of the plurality of benefit rules disagreeing with at least one of the plurality of requirements; and an interface module which acquires the plurality of benefit rules, acquires the plurality of requirements, and outputs identified disagreeing at least one of the plurality of benefit rules.

Optionally, the system further comprises a requirement generating module, the requirement generating module generating the plurality of requirements by converting at least one of a law and a policy into the plurality of requirements

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of a method of verifying compliance of an adjudication platform with a requirement, according to some embodiments of the present invention;

FIG. 2 is an illustration of elements used for verifying compliance of an adjudication platform and its benefit rules with a requirement, according to some embodiments of the present invention;

FIG. 3 is a relational view of software and hardware components of a system for verifying compliance of an adjudication platform with a requirement, according to some embodiments of the present invention;

FIG. 4 is an illustration of an exemplary verification of an adjudication platform conforming to a Glaucoma test requirement, according to some embodiments of the present invention;

FIG. 5 is an illustration of an exemplary Control Flow Graph (CFG) representing an adjudication platform which is not in agreement with a Glaucoma test requirement, according to some embodiments of the present invention; and

FIG. 6 is an algorithm used for iterating over nodes of a control flow graph, according to some embodiments of the present invention.

### DETAILED DESCRIPTION

The present invention, in some embodiments thereof, relates to adjudication platforms and, more specifically, but not exclusively, to verification of adjudication platforms' benefit rules compliance with requirements and ongoing management of adjudication platforms.

As used herein, the term “requirement” means a requirement, an instrument containing a set of rules. The rules may have the force of the law and/or may represent an entity's matter of course. A requirement may be a federal law, a state law, a federal requirement, a state requirement, a policy, and/or guidelines. The requirement may be provided as a written document, a set of logical expressions, a code in a machine readable format and other forms and formats capturing a requirement.

Policies, such as real estate insurance policies, health adjudication platforms etc., have to comply with requirements, such as federal mandates, state laws, state requirements etc. For example, the state of New Jersey mandates that yearly blood glucose tests should be covered for all adults who are over 20 years old, and that glaucoma eye tests are covered every 5 years for adults over age 35.

Requirements are in an ever changing state as new requirements are issued, and existing requirements are updated. Health policies, and the adjudication platforms representing them, have to keep up with these changes. Federal mandates require that the official orders are implemented within the adjudication platform product. Implementing such official orders as part of an adjudication platform product is difficult as the ontology, sequence, relationship types between elements, and/or logic may differ between the official order and the policy.

Adjudication platforms customization may become a source of implementation faults. It is important for owners, such as insurance companies, healthcare providers and organizations providing claim processing services, to track and govern such exceptions, and to identify exceptions which are not implemented correctly within the policy. It is also important to identify variants of the adjudication platform product when migrating to a new health adjudication platform management system.

Automated computerized adjudication platforms implementing adjudication platforms, as any other software, go through ongoing code maintenance. Changes to code may modify its self-consistency, its agreement with the policy it represents and/or its compliance with requirements.

Assessing compliance of an adjudication platform with a requirement can be performed by: 1) Conducting a manual inspection of the implemented benefit rules within a policy 2) Testing exemplary claims in a “black box” approach. Both possibilities are error-prone and labor-intensive processes.

For the purpose of illustration, embodiments of the present invention will be demonstrated herein using a specific example of a health insurance program.

Embodiments of the present invention enable automated verification of health policy implementations compliance with a health policy. An adjudication platform is implemented as a computerized model. The code of such a computerized model contains benefit rules of the adjudication platform and the sequence, hierarchy and/or flow between them. A graph, such as a Control Flow Graph (CFG) is generated according to this code. Each requirement is applied to the graph to inspect its compliance. The application is performed by choosing a subset of relevant benefit rule eligibility characteristics and assigning combinations of numerical eligibility characteristics and/or textual tags in them. The results of these assignments are inspected for compliance with the requirements and/or for self-consistency.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electro-magnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Reference is made to FIG. 1, which is an illustration of a method 100 of verifying compliance of an adjudication platform with a requirement, according to some embodiments of the present invention. The adjudication platform comprises a plurality of benefit rules. Each benefit rule comprises one or more adjudication platform variable. Optionally, each benefit rule is translated to one or more logical language statements. These logical language statements may be represented as a mathematical graph. The resulting mathematical graph represents the adjudication platform in part or as a whole. Each requirement represents a law and/or a policy. Requirements may be generated by converting a law and/or a policy into a set of requirements. Each requirement comprises a plurality of eligibility characteristics. First a requirement is applied to benefit rules 101 representing an adjudication platform. The application of a requirement to benefit rules may be performed by choosing a subset of the benefit rules eligibility characteristics. The subset is chosen according to the applied requirement. Eligibility characteristics are assigned to each subset of eligibility characteristics. Optionally, all possible eligibility characteristic combinations are assigned for applying the requirement. Optionally, formulas are assigned to the subset instead of eligibility characteristics. Then, at least one of said plurality of benefit rules disagreeing with at least one of said plurality of requirements is identified 102. If no discrepancy between the applied requirement and the benefit rules exists, no benefit rule(s) and/or requirement(s) are identified. Optionally, a compliance indication is provided. Finally, an identified benefit rule(s) and/or a requirement(s) are provided as an output 103. Optionally, the steps of this method (applying a requirement, identifying disagreeing benefit rules and outputting) are repeated upon revision of the adjudication platform and/or revision of a requirement. Optionally, the revision is automatically detected.

According to some embodiments of the present invention, the compliance of an adjudication platform's implementation with those same adjudication platform guidelines is examined. The adjudication platform has two roles here: one as a requirement and another as benefit rules of an adjudication platform, allowing the adjudication platform to be applied to it-self. The adjudication platform may be provided as two different representations: for example as a source code implementation and as a graph. The two representations may be generated by different generation processes: employing diverse generation methodologies and/or dissimilar creators. Disparity in generation processes may lead to disparity in faults of adjudication platform representing. Each representation may involve one or more steps of translation, conversion and/or transformation. Each of these steps is prone to faults and errors. Different presentation generation processes may result in different faults and/or errors in the result presentation. Unalike presentations are not likely to harbor the same faults and/or errors. Comparing the presentations may reveal these faults and/or errors should they occur, and enable to verify the correctness of the adjudication platform presentation.

Reference is also made to FIG. 2, which is an illustration of elements used for verifying compliance of an adjudication platform and its benefit rules with a requirement, according to some embodiments of the present invention. An adjudication platform, and its benefit rules, is represented here as a graph 210, 230, 240. The graph may represent the entire adjudication platform or part(s) of it. The graph may be a Control Flow Graph (CFG), a Static Single Assignment (SSA) graph, a plan calculus and/or any other graph that represents control properties of a program. A CFG typically has test nodes 210, 230, 240 and computation nodes (not shown). As used herein, the term test node means a vertex in a graph which is associated with a decision regarding the flow in the graph. As used herein, the term computation node means a vertex in a graph which is associated with a calculation. The decision may be, for example, a propositional function. As used herein, the term propositional function means a statement expressed in a way that would assume the eligibility characteristic of true or false, except that within the statement is one or more characteristics which are undefined or not specified, which leaves the statement undetermined. A test node may have two outgoing edges: a true edge and a false edge. The true out edge may be associate with a target. The false out edge maybe associated with the next test node and/or with other target. The edges of the CFG are, for example, oriented control edges. Each edge 222, 223 is associated with a propagation function 220, 221. As used herein, the term propagation function 220, 221 means one or more conditional instructions which determine a flow. When a propagation function 220, 221 is associated with an edge 222, 223 it determines how data flow along that edge 222, 223 according to the conditional instructions' validity. End nodes, not shown here, having incoming edges but not out coming edges, may be associated with target eligibility characteristics 232, 242 instead of a propositional function 212. Exemplary target eligibility characteristics comprise: co-pay rate in a health insurance, maximum excess rate and/or lump sum in life insurance. The CFG 200 may contain only test nodes 210, 230, 240 without computation nodes. Optionally, the adjudication platform is implemented as a computer code. The code contains rules of the adjudication platform and the flow between them. A CFG 200 is generated according to this code. The adjudication platform's benefit rules and the flow between then become propositional formulas 212 and propagation formulas 220, 221.

For brevity, the following is formally defined:

Let m 210 and n 230 be nodes in a CFG graph. Each node in the graph is associated with a propositional function fᵥ. Here node m 210 is associated with the propositional function fᵥ(m,n) 212.
Let Vᵥ be the set of all eligibility characteristics of a propositional function fᵥ(m,n) 212.
An edge from node m 210 to node n 230 is denoted (m,n) 222. Each edge (m,n) 222 is associated with a propagation function 220 denoted fₑ(m,n). The propagation function 220, fₑ (m,n), represents the change of the relevant data as control passes from the start of m 210 to the start of n 230.
Let Vₑ be the set of all eligibility characteristics of a propagation function 220, related to an edge, fₑ(m,n). Vₑ is the same as or a subset of Vᵥ (the domain of the input)—the set of all eligibility characteristics of a propositional function. fv(m,n) is the result.
Let P(A) be the set of all assignment as 211. P(A) is the entire set of combinations of Vv—the set of all eligibility characteristics of a propositional function fv(m,n) 212. A claim, such as a medical claim for a health adjudication platform, is represented by a particular assignment to Vv.
Let C be a set of assignments (i.e. claims) 211 that are associated with node m 210. When applying the propagation function 220, fe(m,n), to C 211—the result is an assignment set C′ 231: fe(m,n) (C)=C′. C′ 231 is equal to or a subset of C 211.

Optionally, each test node 210 has two edges: etrue 222 and efalse 223 leading to true and false successors: 230 and 240. Each edge 222, 223 is associated with a true or false propagation function ƒₜᵣᵤₑ 220 and ƒ_{false} 221.

fₜᵣᵤₑ(1)={s|sε1 [symbol] s/=aₜ}
ƒ_{false}={s/sε1 [symbol] |s/=aₜ}

Reference is also made to FIG. 3, which is a relational view of software and hardware components of a system 300 for verifying compliance of an adjudication platform with a requirement, according to some embodiments of the present invention. The system 300 comprises: a processor 301, a calculation module 302 and an interface module 303. The calculation module 302 uses the processor 301 to apply a requirement to an adjudication platform. The adjudication platform comprises multiple benefit rules, and the requirement comprises multiple requirements representing a law and/or an adjudication platform. The adjudication platform and requirement are as described in FIGS. 1 and 2. The calculation module 302 identifies benefit rule(s) disagreeing with any of the applied requirement(s). The method used for identifying these disagreements may be as described in FIG. 1. The interface module 303 acquires the adjudication platform. The interface module 303 acquires, for example receives or accesses, the requirement. The interface module 303 outputs the identified disagreements. The output may comprise one of more benefit rules and/or one or more requirements. For brevity, it should be noted that computing functions described herein may be performed using the processor 301. The system 300 may be implemented as a network design platform, an add-on to an existing network design platform, and/or as a software as a service (SaaS) which provides services for users via client terminals.

Optionally, the calculation module 302 may explore alternative benefit rules which correct the disagreement with the requirements. The output may further indicate such alternative benefit rules. Optionally, the system 300 also comprises a requirement generating module. The requirement generating module generates one or more requirement(s) by converting a law and/or an adjudication platform into multiple requirements. The requirement generation may comprise a conversion, adaptation, translation, transformation and/or formatting of a law and/or an adjudication platform into a desired representation suitable for the calculation module 302 such as a set of logical statements, logical expressions, a mathematical graph, a CFG, a machine readable code and/or a flowchart.

Reference is also made to FIG. 4, which is an illustration of an exemplary verification of an adjudication platform 400 conforming to a Glaucoma test requirement, according to some embodiments of the present invention. For the purpose of illustration, embodiments of the present invention will be demonstrated herein using an exemplary embodiment of a health insurance program. In this exemplary embodiment, an adjudication platform product is the adjudication program, and health benefit rules are the underwriting rules which are used to evaluate copay results for insurance cases according to different health care arguments. The underwriting rules may be supplied in a context free grammar. The goal here is to verify that a specific adjudication platform 400 conforms to a requirement regarding Glaucoma testing. The Glaucoma requirement requires that a Glaucoma test will be provided at no charge to a patient 35 years or older once every 5 years. This requirement is converted from written language text to a logical expression, stating as follows:

IF age>=35 years and #_of_claims(procedure=Glaucoma_test, period=5 years)=0 THEN copay=$0
The glaucoma test provision is transformed into the following representation:
Age_over_{—}35∩number_of_claims_glaucoma_test_in_{—}5_years_is_{—}0→copay_{—}0
An adjudication platform implements benefit rules, among them the following health benefit rule:
IF age>=35 years and #_of_claims(procedure=Glaucoma_test, period=5 years)=0 THEN copay=$0
This benefit rule is introduced as a set of Boolean eligibility characteristics in a logical expression:
IF age<35 years or number_of_claims(procedure=Glaucoma_test, period=5 years)>0 THEN copay=$100
When coded, the condition (age>=35) is transformed into the Boolean argument ‘age_over_{—}35’ which may be assigned an eligibility characteristic of 1 if true or 0 if false. Similarly, the condition number_of_claims(procedure=Glaucoma_test, period=5 years)=0 is transformed into the Boolean argument: number_of_claims_glaucoma_test_in_{—}5_years_is_{—}0.
The Boolean expressions are then represented as propositional functions 212 in a graph 400:
! Age_more_then_{—}35 Or ! number_of_claims_glaucoma_test_in_{—}5_years_is_{—}0
This Boolean expression 401A is associated with a test node 401. The graph elements are as described in FIG. 2. It is the purpose of this exemplary embodiment to examine whether the implementation of the adjudication platform (i.e. its graph representation 300) conforms to the Glaucoma test requirement. Exploring all possible assignments of all eligibility characteristics imposes a huge time and space complexity. For that purpose arguments related to the requirement are identified:
The age of the insured customer, denoted herein as ‘age’.
The number of claims made by the customer for glaucoma test in a period of 5 years is denoted as number_of_claims (procedure=Glaucoma_test, period=5 years).
   Overall 2 arguments are identified. Two additional eligibility characteristics are added to the group of identified arguments: Top which denotes a Boolean variable which is always assigned an eligibility characteristic of true (1) and Bottom which denotes a Boolean variable which is always assigned an eligibility characteristic of False (0). All the possible assignments for this eligibility characteristics group, denoted herein as S, are considered:

L = {
top,
bottom,
{ Age_over_35 = 0,
number_of_claims_glaucoma_test_in_5_years_is_0 = 0 },
{ Age_over_35 = 0,
number_of_claims_glaucoma_test_in_5_years_is_0 = 1 },
{ Age_over_35 = 1,
number_of_claims_glaucoma_test_in_5_years_is_0 = 0 },
{ Age_over_35 = 1,
number_of_claims_glaucoma_test_in_5_years_is_0 = 1 }
}

S 411 denotes the assignments which meet the glaucoma test provision, and is selected as:

S={{Age_over_{—}35=1, number_of_claims_glaucoma_test_in_{—}5_years_is_{—}0=1}}
S 411 is a subset of L. Here S 411 is the input for the first test node 401. The node 401 has two propagation functions 404, 405 which are related to the propositional function 401A: A true eligibility characteristic for the propositional function 401A is represented by the propagation function of the right-hand edge 405, while a false eligibility characteristic for the propositional function 401A is represented by the propagation function of the left-hand edge 404. Applying the left-hand propositional function to S 411 results in an empty set. This agrees with the requirement as none of the assignments of S should result in a co-pay of $100 according to node 402. Applying the right-hand propositional function to S 411, results in the assignment set 413. The assignment set 413 and S 411 are identical. This agrees with the requirement all of the assignments of S should result in a co-pay of $0 according to node 403. The verification concludes that the adjudication platform implementation 400 conforms to the Glaucoma test requirement.

Reference is also made to FIG. 5, which is an illustration of an exemplary Control Flow Graph (CFG) representing an adjudication platform 500 which is not in agreement with a Glaucoma test requirement, according to some embodiments of the present invention. The graph 500 elements are as described in FIG. 2. Unlike the previous example, in FIG. 4, there is a reachable outcome 505A (co-pay=$100) which does not satisfy the glaucoma test requirement, and therefore the requirement is not implemented within the health benefit rules of this adjudication platform 500. The adjudication platform 500 implements the following expressions:

IF #_of_claims(procedure_category=Wellness , period=1

years) >3 THEN copay=$100

IF age <35 years or #_of_claims(procedure=Glaucoma_test ,

period=5 years) > 0 THEN copay=$100

In the graph, each elliptical node 504, 505, 401-403 represents a test node and is associated with a propositional function 212 or a target eligibility characteristic 402A, 403A, 505A. The horizontal line 501 splits the graph 500 into two parts: upper 502 and lower 503. The lower part 503 is as described in FIG. 4. The upper part 502 depicts a test node 504 associated with a propagation function 504A. Two output edges 505, 506 come out of this node 504. The propositional functions 504A, 410 have, as an example, Boolean eligibility characteristics. The propagation functions are True or False assessments of the propositional functions. For example, edge 505 is the false assessment and edge 506 is the true assessment of the propositional function 504A. Edge 505 leads to node 401 as described in FIG. 4, while edge 506 leads to an end node 505 associated with a target eligibility characteristic of 100 dollar co-pay. The assignment to the adjudication platform starts with S 411 as described in FIG. 4. The propagation function 505A associated with node 505 introduces a new variable: number of wellness claims (number_of_claims_wellness_in_{—}1_year_over_{—}3). The newly introduced variable is recognized, using domain knowledge, as a super set of the glaucoma test variable. The assignment set S 411 is updated to include the various assignments of this newly introduced variable. The propagation functions associated with edges 505, 506 represent False and True of 504A (not shown). These functions are then each applied to the updated assignment. The results of these applications are 512 and 513 respectively. The node 505 is reached with assignment group 513. This assignment 513 is recognized as conforming to the requirement. Since this assignment 513 leads to node 505 which is associated with the target eligibility characteristic 505A of 100 dollar co-pay—it is a fault. This discrepancy may be reported by outputting the associated node 505, the entire graph path leading to 505, the target eligibility characteristic 505A, the assignment 513, the examined requirement and/or a combination thereof. The other two assignment sets 514, 515 leading to target eligibility characteristics 402A and 403A respectively are identified as correct. Examined correct results may or may not be reported.

Reference is also made to FIG. 6, which is an algorithm used for iterating over nodes of a control flow graph, according to some embodiments of the present invention. This algorithm extends the set of assignments with the missing interesting variables. Propositional formulas in the form of IF a THEN b (or a→b) are built within the program, such that ‘a’ is a logical Boolean expression containing adjudication arguments relevant to a specific context, referred to herein as context eligibility characteristics. Referring to the abovementioned example, ‘a’ may be the logical Boolean expression ‘age>35’ and ‘age’ is identified as a context variable. Then, a set of adjudication case assignments which satisfy a is constructed, the set denoted herein as S. Adjudication case assignments include eligibility characteristic assignments for each of the context eligibility characteristics which appear in each of the logical expressions of the propositional formulas. Evaluation iterations are performed for each of the adjudication case assignments in S. A provision is implemented within the set of underwriting rules if all non-empty outcomes of a control flow graph satisfy ‘b’. Optionally, a theorem “prover” and/or satisfiability (SAT) solver are used for generating the subset of the assignments of the input state. The input state may be extended to full assignment satisfying a given formula and/or constraint.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms adjudication frameworks, simplification instructions and appraisal table is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of verifying compliance of a plurality of benefit rules with a plurality of requirements, said method comprising:
acquiring a plurality of benefit rules of an adjudication platform;
applying a plurality of requirements representing at least one of a law and an insurance policy to said plurality of benefit rules;
identifying at least one of said plurality of benefit rules disagreeing with at least one of said plurality of requirements, responsive to a discrepancy between applied plurality of requirements and said plurality of benefit rules;
outputting at least one of identified said plurality of benefit rules and said plurality of requirements.

2. The method of claim 1, wherein said applying a plurality of requirements to said plurality of benefit rules is performed by:
identifying a plurality of assignments for at least one of said plurality of requirements;
associating at least one subset of said plurality of assignments with at least one of said plurality of benefit rules according to agreement of said at least one subset with said at least one of said plurality of benefit rules;
choosing a second benefit rule from said plurality of benefit rules according to at least one relationship of said second benefit rule with said at least one of said plurality of benefit rules;
adding at least one assignment for said second benefit rule to said at least one subset;
comparing an eligibility result of said second benefit rule with an expected result of said at least one of said plurality of requirements.

3. The method of claim 2, further comprising repeating said choosing and adding until at least one of getting to an eligibility result and identifying a logical contradiction between said plurality of assignments.

4. The method of claim 2, wherein said plurality of assignments includes all possible assignments.

5. The method of claim 2, wherein said plurality of assignments comprises at least one of a plurality of numerical eligibility characteristics, a plurality of textual tags, and a plurality of formulas.

6. The method of claim 2, wherein discrepancy between applied plurality of requirements and said plurality of benefit rules is at least one of:
a contradiction between said plurality of assignments,
a contradiction between a plurality of variables of an assignment from said plurality of assignments,
an empty assignment set,
a difference in an eligibility result of at least one of said plurality of benefit rules and an eligibility result of at least one of said plurality of requirements and
a benefit rule which is never assessed.

7. The method of claim 2, wherein said at least one relationship is at least one of a sequence and a hierarchy.

8. The method of claim 2, wherein said identifying a plurality of assignments for at least one of said plurality of requirements is performed by at least one of satisfiability solver, theorem prover and abstract interpretation.

9. The method of claim 1, further comprising:
automatically recognizing a revision of at least one of said plurality of benefit rules;
automatically repeating said applying, said identifying and said outputting responsive to said revision.

10. The method of claim 1, further comprising:
automatically recognizing a revision of at least one of said plurality of requirements;
repeating said applying, said identifying and said outputting upon a revision of said plurality of benefit rules.

11. The method of claim 1, wherein said at least one of a law and an insurance policy comprises a member of a group consisting of: a state regulation, a state law, a federal regulation, a federal law, and guidelines of an insurance policy.

12. The method of claim 1, wherein said plurality of requirements are generated by converting at least one of a law and an insurance policy.

13. The method of claim 1, further comprising:
translating each of said plurality of benefit rules to at least one logical language statement;
representing said at least one logical language statement as a mathematical graph.

14. The method of claim 13, wherein
said mathematical graph comprises a plurality of nodes and a plurality of edges; and
said representing said at least one logical language statement as a mathematical graph comprises associating a plurality of propagation functions with said plurality of edges, wherein each propagation function is one or more conditional instructions determining data flow along associated edge according to validity of said conditional instructions.

15. The method of claim 14, further comprising:
associating at least one subset of a plurality of assignments with at least one of said plurality of propagation functions.

16. The method of claim 1, wherein when said plurality of benefit rules comply with said plurality of requirements said outputting comprises a compliance indication.

17. The method of claim 1, wherein:
said plurality of benefit rules represent an adjudication platform;
said plurality of requirements represents said adjudication platform; and
a representation of said plurality of benefit rules differs from a representation of said plurality of requirements.

18. The method of claim 1, further comprising:
acquiring a relationships database indicating at least one of:
a plurality of relationships between a plurality of benefit rule eligibility characteristics, each defining a characteristic for complying with a benefit rule;
a plurality of relationships between a plurality of requirement eligibility characteristics, each defining a characteristic for complying with a requirement;
a plurality of relationships between at least one of said plurality of benefit rule eligibility characteristics and at least one of said plurality of requirement eligibility characteristics;
wherein said identifying at least one of said plurality of benefit rules disagreeing with at least one of said plurality of requirements, utilizes at least one of said plurality of relationships of said relationships database.

19. The method of claim 18, wherein said plurality of relationships comprises: a type-of relationship, a containing relationship, a part-of relationship and a is-a relationship.

20. A computerized method of verifying self consistency of an adjudication platform, the method comprising:
assigning at least one of a plurality of formulas and a plurality of eligibility characteristics to a plurality of benefit rules representing an adjudication platform;
identifying a fault in at least one of said plurality of benefit rules, said fault comprising: a contradiction between said plurality of benefit rules, repetition of a benefit rule, a benefit rule which is always true, a benefit rule which is always false and a benefit rule which is never assessed.

21. A computer program product for verifying compliance of a plurality of benefit rules with a plurality of requirements, comprising:
a computer readable storage medium;
first program instructions to apply a plurality of requirements to plurality of benefit rules;
second program instructions to identify a discrepancy between applied said plurality of requirements and said plurality of benefit rules; and
third program instructions to output said discrepancy;
wherein said first, second and third program instructions are stored on said computer readable storage medium.

22. A system for verifying compliance of a plurality of benefit rules with a plurality of requirements, said system comprising:
a processor;
a calculation module which, using said processor, applies a plurality of requirements to a plurality of benefit rules, wherein said calculation module identifies at least one of said plurality of benefit rules disagreeing with at least one of said plurality of requirements; and
an interface module which acquires said plurality of benefit rules, acquires said plurality of requirements, and outputs identified disagreeing at least one of said plurality of benefit rules.

23. The system of claim 22, further comprising a requirement generating module, said requirement generating module generating said plurality of requirements by converting at least one of a law and an insurance policy into said plurality of requirements.
